(19) United States
(12) Patent Application Publication
(10) Pub. No.: US 2014/0108067 A1
(43) Pub. Date: Apr. 17, 2014

(54) USING QUALIFICATION EVENTS TO PROVIDE PRICE DIFFERENTIATION FOR TRAVEL PRODUCTS

(71) Applicant: GetGoing, Inc., San Francisco, CA (US)

(72) Inventors: Ilya Gluhovsky, Daly City, CA (US); Alek Vernitsky, San Francisco, CA (US); Alek Strygin, Foster City, CA (US)

(73) Assignee: GetGoing, Inc., San Francisco, CA (US)

(21) Appl. No.: 14/051,211

(22) Filed: Oct. 10, 2013

Related U.S. Application Data
(60) Provisional application No. 61/712,342, filed on Oct. 11, 2012.

(51) Int. Cl. G06Q 10/02; G06Q 30/02

(52) U.S. Cl. CPC G06Q 10/02; G06Q 30/0207
USPC 705/5

(57) ABSTRACT

The disclosed embodiments provide a system that facilitates a purchase of a travel product. Upon detecting a participation of a user in a first qualification event associated with a first market segment, the system associates the user with the first market segment. Next, the system provides the user with a first discount offer on a first travel product associated with the first market segment. Upon obtaining an acceptance of the first discount offer from the user, the system uses the first discount offer to process a purchase of the first travel product by the user.

### RELATED APPLICATIONS

This application claims the benefit of U.S. Provisional Application No. 61/712,342, Attorney Docket Number GG12-1005PSP, entitled “Method and Apparatus for Price Differentiation Using Pre-Qualification Events,” by inventors Ilya Gluhovsky, Alek Vernitsky and Alek Strygin, filed 11 Oct. 2012, which is incorporated herein by reference.

The subject matter of this application is related to the subject matter in a co-pending non-provisional application by inventors Alek Vernitsky, Alek Strygin and Ilya Gluhovsky, entitled “System and Method for Facilitating the Purchase of a Travel Itinerary Subject to Destination Uncertainty,” having Ser. No. 13/656,458 and filing date 19 Oct. 2012 (Attorney Docket No. GG12-1001).

The subject matter of this application is also related to the subject matter in a co-pending non-provisional application by inventors Alek Vernitsky, Ilya Gluhovsky and Alek Strygin, entitled “Reducing Selection Uncertainty of Opaque Sales of Travel Products,” having Ser. No. 14/042,138 and filing date 30 Sep. 2013 (Attorney Docket No. GG12-1002).

The subject matter of this application is also related to the subject matter in a co-pending non-provisional application by inventors Alek Strygin, Alek Vernitsky and Ilya Gluhovsky, entitled “Using Upgrade Options to Provide Price Differentiation for Travel Products,” having Ser. No. 14/021,598 and filing date 9 Sep. 2013 (Attorney Docket No. GG12-1003).

The subject matter of this application is also related to the subject matter in a co-pending non-provisional application by inventors Alek Vernitsky, Alek Strygin and Ilya Gluhovsky, entitled “System and Method for Facilitating the Purchase of a Travel Itinerary Subject to Date Uncertainty,” having Ser. No. 13/656,466 and filing date 19 Oct. 2012 (Attorney Docket No. GG12-1009).

### BACKGROUND

1. Field

The disclosed embodiments relate to market segmentation and price differentiation. More specifically, the disclosed embodiments relate to techniques for using qualification events to provide price differentiation of travel products.

2. Related Art

Differential pricing, which includes product differentiation and price discrimination, is a pricing strategy commonly used by businesses for selling products like airline seats, hotel rooms, and/or other travel products. Differential pricing is used to sell the right number of products to targeted customers for an appropriate price in order to maximize profit from a fixed, perishable resource. Price discrimination or price differentiation refers to the practice of charging different prices for the same (or very similar) products that have the same costs of production, based solely on different consumers' willingness to pay (WTP). Product discrimination, on the other hand, involves charging different prices for products with different quality of service characteristics and, in general, different costs of production. Revenue systems utilize both price discrimination and product differentiation in an attempt to maximize yield. They offer a variety of products, involving differences in the qualities of service, as well as differences in the purchase according to conditions and restrictions.

A related strategy is market segmentation, which refers to classifying individuals or identifying different demand groups or segments. Market segmentation techniques are used in order to maximize revenues from sale of a fixed, perishable commodity, such as a seat on an airline, a hotel room, cruises, car rental, or any other such products. In theory, total revenue from a product is maximized when each consumer pays a different price equal to his or her WTP. In practice, such a theoretical segmentation cannot be achieved as the system cannot determine each individual WTP for each particular product, nor can it publish different prices available only to specific individuals.

FIG. 1A illustrates a price demand curve used for price differentiation in airlines. The entire area under the sloping line represents the maximum revenue that an airline may derive from a given flight. If the airline offers an unrestricted fare P1 (price) to those consumers with a higher WTP, the airline can expect Q1 (quantity) consumers to purchase the fare because they have WTP equal to P1 or greater. However, the airline may leave a lot of revenue on the table, both because it did not charge a higher price for those consumers who have WTP>P1, and also because a number of seats are flying empty, as many consumers with WTP<P1 did not buy a ticket.

FIG. 1B illustrates a graphical representation of a typical differential pricing technique of a product. If the airline offers a lower or discount fare P2 to those consumers with a lower WTP, then Q2−Q1 additional consumers would be expected to purchase the lower fare, as they have WTP greater than P2 but less than P1. By introducing two fares, the airline is able to capture a greater portion of the total available revenue. This model assumes that consumers with a high WTP purchase the higher fare P1. Price discrimination presents a challenge of identifying and segmenting customers based on the strength of their preference for a specific product. Without it, profit/yield and market reach of a product are reduced.

For example, consumers prefer high-quality goods over low-quality goods, if prices for all goods are the same. By introducing products of different quality and at different prices, the airlines try to segment the market into consumers with higher and lower WTP. First class, business, premium economy, and economy cabins, as well as tickets that come with expedited security services, priority boarding, and lounge access, are all examples of product differentiation. Furthermore, fare classes and fare basis codes are the most important yield management innovation introduced by the airlines. Fare basis codes are used for selling less desirable flights more cheaply, such as those flying mid-week or off-season, in combination with booking classes, as well as imposing fare rule penalties on refunds and/or exchanges, thus constituting product differentiation. On the other hand, two prime examples of price discrimination, also often achieved using fare basis codes, are providing corporate discounts and (separately) imposing an advanced purchase restriction. Thus, corporate customers often get a price break on the same product thanks to the volume sales a corporation achieves. Similarly, the same seat being sold far in advance is typically cheaper than that sold at the last minute. A typical problem with the latter strategy is that it locks out prospective low-WTP customers who were unable or unwilling to commit to travel in advance while precluding an airline from dropping last-minute prices, so that business customers stepping on a plane at the last minute do not catch the same price break and discretionary customers do not develop a habit of buying cheap travel late.

There are other approaches used by airline service providers to sell tickets with offers which yield profits and also optimize the revenue and managing inventory for the airline, thus ensuring to supply consumers with the best products for which they are willing to pay. For example, a prospective purchaser purchasing an airline ticket may commit to purchasing an airline ticket at a reduced price, but the transaction may only occur if the seller makes the ticket available at a designated time near the date of departure. In such scenarios, the utility in a commercial sale of airline tickets is limited. First, the buyer is required to make a commitment in advance without any certainty of getting on a flight.

Second, the buyer is effectively precluded from booking a hotel at his chosen destination because of the uncertainty that the trip will occur, and booking a last-minute hotel may offset any savings from the discounted airfare. Third, on routes with frequent last-minute seat availability, many buyers are likely to adjust their behavior and postpone the full price purchase in favor of an acquisition uncertainty ticket. This creates more empty seats and perpetuates a vicious cycle. Thus, the consumer is not sure whether the ticket will be booked or not till near the date of departure.

Another approach of revenue management by airlines is, for example, a Name-Your-Own-Price® (NYOP®) distribution platform that sells opaque fares through buyer-driven pricing. In this NYOP® platform (also referred to as the “Priceline® system”), a customer makes a conditional purchase offer by specifying some characteristics of the itinerary (such as origin, destination, and dates) and the price he/she is willing to pay. The request is a commitment by the customer to buy at the offered price. Once the request is made, the Priceline® system searches for an airline that is willing to sell a flight ticket below that price and sends an accept/reject decision back to the customer within a specific time period. If the airline accepts the offer (i.e., a fare exists at or below the buyer-requested price), the flight is booked and the customer is charged. Priceline® keeps the margin between the customer-quoted price and the airline price.

Hotwire® offers a platform where, instead of buyer-driven pricing, the price is disclosed upfront, while the details of the itinerary remain opaque until after the purchase. The opaque sales channels are inferior, both from the airline perspective and from the customer perspective. The opaqueness of the fare downgrades the product by making it less valuable in an attempt to discourage consumption by the high-WTP customers. NYOP® customers must accept considerable uncertainty over the details of their itinerary, including not knowing the airline they will fly, the number of connections, or the exact times of arrival and departure.

In the Priceline® system's implementation, customers are also required to guess the price of an airline ticket and, in an attempt to discourage repeat bidding, wait for a period of time before making another offer. Thus, a buyer may be required to spend a considerable amount of time only to end up with a suboptimal product. In addition, many high-WTP customers exhibit low-WTP behavior. While some business and leisure travelers are likely to be discouraged by the deliberate uncertainty introduced into the transaction (in terms of arrival time, routing, and number of stops), others will perceive the opaque fare as a perfect substitute for the non-opaque fare that allows the buyer to travel from origin to destination and return on the specified dates, resulting in the cannibalization of high-WTP fares, including business fares.

Prepaid airline tickets are made available for purchase in advance of the flights so that the buyer may convert to a specific flight itinerary shortly before the departure, within certain specified parameters (such as a range of dates, a type of seat, etc.), and subject to seat availability. Unlike the unspecified-time ticket, the buyer is not forced to accept whatever flight and seat the airline offers, and has more flexibility to choose within a range of seats available at the very last minute. For both seller- and buyer-driven prepaid tickets, the buyer does not have the certainty of ticket availability until the last minute. Also, the itinerary is either opaque (some but not all of its attributes are known) or, if not opaque, may present the buyer with a limited selection of last-minute unsatisfactory choices. Hence, there remains a need for market segmentation and consequent price differentiation while balancing the interests of the airline and/or travel website, where customers are likely to pay close to their individual WTP, with those of a customer, who is least inconvenienced by the price discrimination mechanism.

### SUMMARY

The disclosed embodiments provide a system that facilitates a purchase of a travel product. Upon detecting a participation of a user in a first qualification event associated with a first market segment, the system associates the user with the first market segment. Next, the system provides the user with a first discount offer on a first travel product associated with the first market segment. Upon obtaining an acceptance of the first discount offer from the user, the system uses the first discount offer to process a purchase of the first travel product by the user.

In some embodiments, upon detecting a participation of the user in a second qualification event associated with a second market segment, the system associates the user with the second market segment. Next, the system provides the user with a second discount offer on a second travel product associated with the second market segment.

In some embodiments, the first travel product is associated with a first supplier, and the second travel product is associated with a second supplier.

In some embodiments, the system also provides the user with a second discount offer on a second travel product based on the first market segment and the purchase of the first travel product by the user.

In some embodiments, detecting the participation of the user in the first qualification event involves at least one of enabling participation of the user in the first qualification event, and verifying participation of the user in the first qualification event.

In some embodiments, the participation of the user in the first qualification event includes at least one of accessing one or more travel products associated with the first qualification event, and completing the first qualification event.

In some embodiments, the first discount offer is associated with at least one of a period of validity, a value associated with the first qualification event, a personalized discount, an upgrade option, and use of the first travel product by the user or another user associated with the first qualification event.

In some embodiments, a chain of qualification events and additional user-related information are used to qualify a user for a new discount offer. The chain may include the first and second qualification events and result in the user's qualification for the second discount offer.

In some embodiments, the first and/or subsequent qualification events are associated with at least one of a hurdle, an opaque purchase, a set of purchase options associated with the opaque purchase, an upgrade option, a destination uncertainty, and a schedule uncertainty.

In some embodiments, the first travel product is at least one of a flight, a hotel, a rental car, a cruise, a tour, and a travel package.

### BRIEF DESCRIPTION OF THE FIGURES

FIG. 1A illustrates a price demand curve used for price differentiation in airlines in accordance with the disclosed embodiments.

FIG. 1B illustrates a graphical representation of a typical differential pricing technique of a product in accordance with the disclosed embodiments.

FIG. 2 shows a schematic of a system in accordance with the disclosed embodiments.

FIG. 3 shows an exemplary use of qualification events with a set of discount offers in accordance with the disclosed embodiments.

FIG. 4 shows a flowchart illustrating the process of facilitating a purchase of a travel product in accordance with the disclosed embodiments.

FIG. 5 shows a computer system in accordance with the disclosed embodiments.

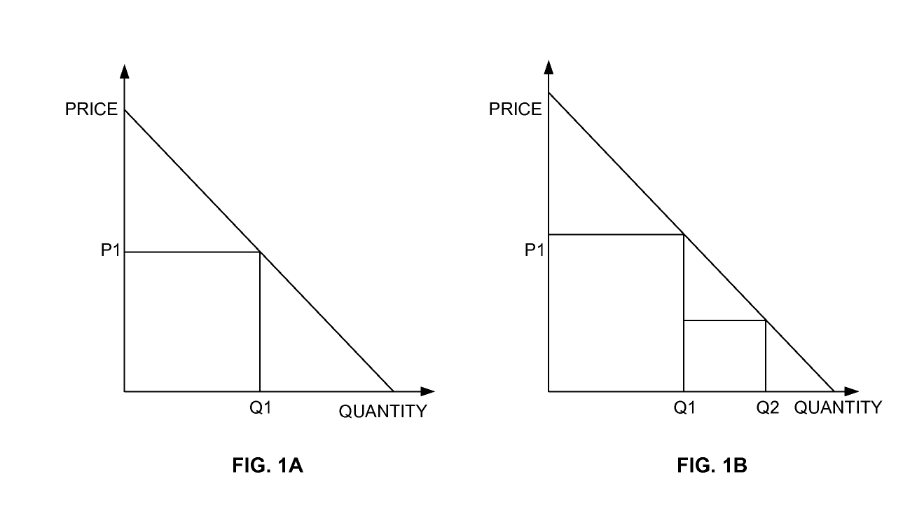

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

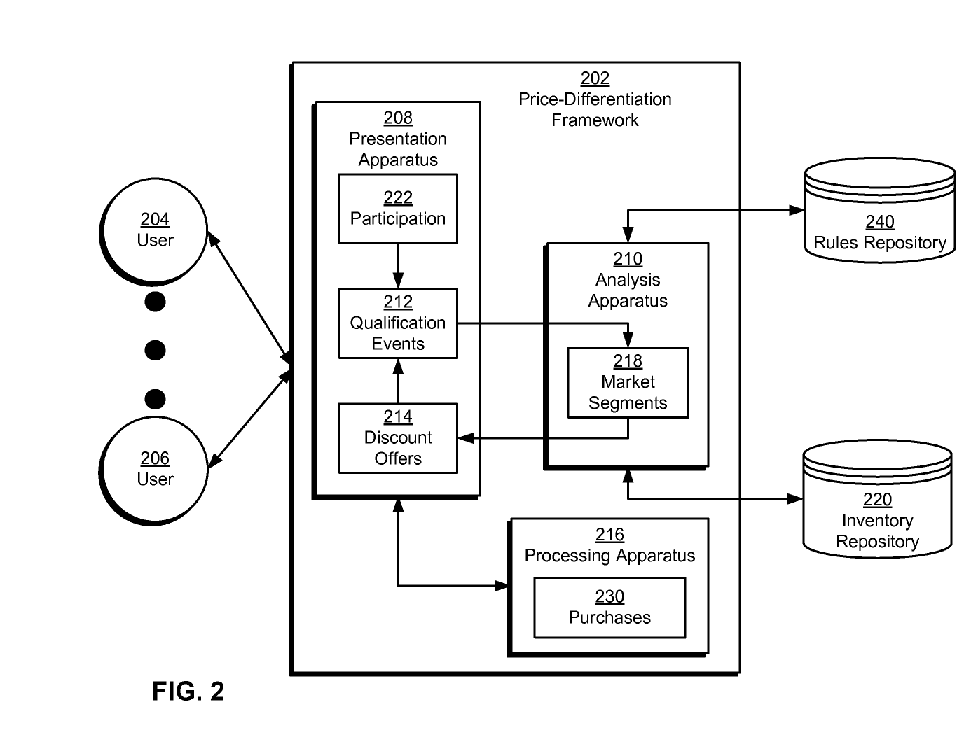

The disclosed embodiments provide a method and system for facilitating the purchase of travel products such as flights, hotels, rental cars, cruises, tours, and/or travel packages. As shown in FIG. 2, the system may correspond to a price-differentiation framework 202 that is accessed by a set of users 204-206, also referred to as “buyers.” Price-differentiation framework 202 includes a presentation apparatus 208, an analysis apparatus 210, and a processing apparatus 216. Each of the components of price-differentiation framework 202 is described below.

In one or more embodiments, price-differentiation framework 202 allows users 204-206 to find and purchase travel products. For example, price-differentiation framework 202 may provide a website for browsing, searching, and/or booking flights, hotels, rental cars, cruises, tours, and/or travel packages. Price-differentiation framework 202 may also be accessed through a natively installed application on an electronic device such as a mobile phone, tablet computer, portable media player, laptop computer, and/or personal computer, in lieu of or in addition to the web-based user interface provided by the website.

Moreover, price-differentiation framework 202 may include functionality to perform market segmentation of users 204-206, which in turn may enable price differentiation of travel products offered and/or sold to users 204-206. To segment users 204-206 into distinct market segments 218, price-differentiation framework 202 may present market-segmentation mechanisms such as hurdles to users 204-206. The hurdles may include restrictions that separate users 204-206 into a first group that is willing to accept the restrictions in exchange for a lower price and a second group that is willing to pay a higher price to avoid the restrictions. For example, the hurdles may be associated with opaque purchases, destination uncertainty, and/or time uncertainty.

During an opaque purchase, a user may specify one or more terms associated with a travel product to presentation apparatus 208. For example, the user may provide a set of travel dates, a star rating, a city, a region within the city, and/or a price for a hotel booking to be conducted using the opaque purchase. Presentation apparatus 208 may provide one or more travel products matching the terms to the user without disclosing one or more identifying details of the travel product(s). Continuing with the above example, presentation apparatus 208 may initially withhold the names or addresses of hotels that match the user's terms. Instead, presentation apparatus 208 may disclose the name and location of a hotel only after the user has committed to booking the hotel.

In exchange for the opacity, price-differentiation framework 202 may offer travel products at a discount over the regular prices of the travel products. For example, price-differentiation framework 202 may allow a user to book a four-star hotel at a price that is normally associated with a three-star hotel. In other words, price-differentiation framework 202 may present a hurdle that constitutes a commitment to purchase a travel product without knowing the identifying details of the travel product. The hurdle may thus segment the market into users who need to know the details of the travel product and are willing to pay the regular price of the travel product and users who are willing to commit to an opaque purchase without knowing the details of the travel product in exchange for a discount. Such segmentation may allow suppliers of travel products to offer lower price points to users in the second category and facilitate the sale of excess inventory while continuing to sell to users in the first category at the normal, higher price point.

The opaque purchase may also be associated with a number of purchase options that are provided to the user after the user has committed to making the opaque purchase. By providing a better fit to the user's needs, the purchase options may reduce the user's risk in purchasing an unidentified travel product. Using purchase options to facilitate opaque purchases of travel products is described in a co-pending non-provisional application by inventors Alek Vernitsky, Ilya Gluhovsky and Alek Strygin, entitled “Reducing Selection Uncertainty of Opaque Sales of Travel Products,” having Ser. No. 14/042,138 and filing date 30 Sep. 2013 (Attorney Docket No. GG12-1002), which is incorporated herein by reference.

Price-differentiation framework 202 may also present a hurdle with destination uncertainty, such as an “alternative destinations” mechanism. The “alternative destinations” mechanism may allow the user to add two or more travel itineraries to different destinations to a shopping cart and commit to purchasing at least one of the selected travel itineraries. Price-differentiation framework 202 may then select one or more of the destinations in the shopping cart and process a purchase (e.g., purchases 230) of a travel itinerary associated with the selected destination(s) for the user before revealing the purchased travel itinerary to the user. Using an “alternative destinations” mechanism to purchase a travel itinerary is described in a co-pending non-provisional application by inventors Alek Vernitsky, Alek Strygin and Ilya Gluhovsky, entitled “System and Method for Facilitating the Purchase of a Travel Itinerary Subject to Destination Uncertainty,” having Ser. No. 13/656,458 and filing date 19 Oct. 2012 (Attorney Docket No. GG12-1001), which is incorporated herein by reference.

Along the same lines, price-differentiation framework 202 may present a hurdle with time uncertainty. Similar to the hurdle with destination uncertainty, the hurdle with time uncertainty may allow the user to add two or more travel itineraries with different departure and/or return dates to a shopping cart and commit to purchasing at least one of the selected travel itineraries. Price-differentiation framework 202 may then select one or more of the travel itineraries in the shopping cart and process a purchase (e.g., purchases 230) of the selected travel itinerary for the user before revealing the purchased travel itinerary to the user. Using hurdles with time uncertainties to purchase travel itineraries is described in a co-pending non-provisional application by inventors Alek Vernitsky, Alek Strygin and Ilya Gluhovsky, entitled “System and Method for Facilitating the Purchase of a Travel Itinerary Subject to Date Uncertainty,” having Ser. No. 13/656,466 and filing date 19 Oct. 2012 (Attorney Docket No. GG12-1009), which is incorporated herein by reference.

In one or more embodiments, price-differentiation framework 202 uses hurdles and/or other market-segmentation mechanisms as qualification events 212 for discount offers 214 that are subsequently presented to users 204-206. First, presentation apparatus 208 and/or another component of price-differentiation framework 202 may detect a participation 222 in one or more qualification events 212 by a user. Participation 222 may be related to the user's access to one or more travel products associated with a qualification event. For example, presentation apparatus 208 may detect the user's participation 222 in the qualification event while the user uses price-differentiation framework 202 to browse and/or search travel products associated with opaque purchases, destination uncertainty, time uncertainty, and/or other hurdles. Alternatively, participation 222 may correspond to the user's completion of the qualification event. For example, the user's participation 222 in the qualification event may not be established until the user completes a purchase (e.g., purchases 230) that is associated with a hurdle (e.g., opaque purchase, destination uncertainty, time uncertainty, etc.).

Moreover, price-differentiation framework 202 may include functionality to accept qualification events 212 from a number of sources. As described above, price-differentiation framework 202 may provide hurdles and/or other market-segmentation mechanisms that are used as qualification events 212, thus enabling the user's participation 222 in the qualification event. On the other hand, price-differentiation framework 202 may verify the user's participation 222 in an eligible qualification event with another travel-booking mechanism. For example, price-differentiation framework 202 may accept a booking confirmation associated with a hurdle from an online travel agency, airline, rental car company, hotel, and/or other travel supplier as evidence of the user's participation 222 in a qualification event associated with the hurdle. In addition, price-differentiation framework 202 may set a time limit (e.g., 48 hours) within which the booking confirmation can be provided to be eligible as a qualification event.

After the user's participation 222 in the qualification event is detected, analysis apparatus 210 may associate the user with a market segment (e.g., market segments 218) based on the qualification event. For example, after the user completes an “alternative destinations” purchase and/or opaque purchase, analysis apparatus 210 may identify the user as a price-conscious, flexible traveler and place the user in the market segment for price-conscious, flexible travelers. On the other hand, the user's lack of participation 222 in any qualification events 212 may indicate that the user is less flexible and/or price-conscious and preclude the user's placement in the same market segment.

Analysis apparatus 210 may also include different market segments 218 representing different types of flexibility and/or levels of price-sensitivity. For example, analysis apparatus 210 may include market segments 218 associated with different numbers and/or types of qualification events 212, hurdles, and/or levels of willingness to pay. As discussed in further detail below, the market segment associated with the user may be changed and/or updated as the user participates in subsequent qualification events 212, which in turn may reveal additional preferences, needs, and/or desires of the user.

Analysis apparatus 210 may then use the user's market segment to select a discount offer (e.g., discount offers 214) on a travel product for the user, which may or may not be from the same supplier as the supplier associated with the qualification event. For example, analysis apparatus 210 may select a discount offer on a hotel room at a destination after the user completes an “alternative destinations” purchase of a travel itinerary to the destination. Because the “alternative destinations” purchase places the user in a price-sensitive “leisure” market segment, the user may not be interested in booking a full-price hotel room at a premium hotel chain. At the same time, the hotel chain may post rates that target inflexible business travelers, resulting in a significant number of unsold rooms, particularly outside of business-related events (e.g., conferences, sporting events, etc.) and/or days associated with business travel (e.g., Monday through Wednesday nights). Consequently, the discount offer on the hotel room may allow the premium hotel chain to receive incremental revenue from the user without cannibalizing revenue from business travelers, who do not have the flexibility to participate in “alternative destinations” purchases.

In addition, the discount offer may be based on a set of rules from a rules repository 240 and/or available inventory of travel products from an inventory repository 220. The rules may describe the applicability of various discount offers 214 to different market segments 218 based on attributes of market segments 218 and/or qualification events 212 associated with market segments 218. The rules may be used to first identify a set of discount offers that may be used with the market segment. A discount offer associated with available inventory from inventory repository 220 may then be selected from the set.

More specifically, the rules may match certain qualification events 212 and/or market segments 218 to discount offers for certain types of travel products. For example, the rules may allow discount offers for car rentals and/or hotels to be provided for qualification events involving purchases of flights. The rules may also specify a period of validity for a discount offer and/or the amount by which the travel product can be discounted. For example, the rules may limit the discount provided in the discount offer to a fraction of a purchase price and/or other value associated with the qualification event to mitigate “gaming” that gives a user a chance to receive a significant discount with the discount offer (e.g., a heavily discounted hotel room) after making a cheap purchase in the qualification event (e.g., cheap airfare).

Moreover, the rules may limit the amount of discounted inventory for which the user is eligible (e.g., after participating in the qualification event) and/or customize the discount offer to the user's behavior and/or preferences, as revealed by the user's previous interaction with price-differentiation framework 202 and/or information provided by the user to price-differentiation framework 202. For example, the rules may select an available hotel room with a particular hotel brand for the discount offer based on the user's previous hotel bookings with the hotel brand. The rules may also determine the amount by which the hotel room is discounted based on the user's price sensitivity, which may be determined from the prices paid by the user for other hotel rooms and/or the user's participation in market-segmentation mechanisms (e.g., qualification events 212) associated with discounts.

Finally, the rules may restrict use of the travel product in the discount offer to the users associated with the qualification event to prevent another user from taking advantage of the discount offer without qualifying for the discount offer. For example, the rules may require the listing of one of the passengers in a travel itinerary purchased during a qualification event as a guest during a discounted booking of a non-transferable hotel room following the qualification event, thus preventing the transfer or sale of the discounted booking to another user who did not participate in the qualification event. Similarly, the rules may limit the amount of the travel product that can be purchased based on the number of users associated with the qualification event. For example, a travel itinerary with four passengers that is booked in a qualification event may be used to generate a discount offer for no more than two double rooms at the destination associated with the travel itinerary.

Once the discount offer is selected, the discount offer is provided to the user by presentation apparatus 208. For example, presentation apparatus 208 may provide details of the travel product associated with the discount offer, the original price of the travel product, the discounted price of the travel product in the discount offer, and/or any restrictions (e.g., non-transferability, period of validity, etc.) on the discount offer. On the other hand, presentation apparatus 208 may obscure one or more details of the travel product if the discount offer is an opaque purchase and/or associated with destination or time uncertainty. In other words, the discount offer may also include a hurdle, which may allow the discount offer to be used as a qualification event for subsequent discount offers, as discussed below.

If the user accepts the discount offer, processing apparatus 216 may use the discount offer to process a purchase (e.g., purchases 230) of the travel product. For example, presentation apparatus 208 and/or processing apparatus 216 may confirm the details of the purchase (e.g., dates, schedule, location, discounted price, number of travelers, etc.) with the user, obtain payment (e.g., credit card, debit card, electronic check, online payment) information from the user, and perform the purchase using the payment information.

As mentioned above, the user's participation 222 in the qualification event may be detected before the qualification event completes (e.g., before the user makes a purchase associated with the qualification event). To increase the attractiveness of completing the qualification event, presentation apparatus 208 may indicate the availability of the discount offer during the user's participation 222 in the qualification event. For example, presentation apparatus 208 may inform the user of the availability of a discounted hotel room following an “alternative destinations” flight purchase while the user browses and/or searches for travel itineraries to place into the shopping cart for the “alternative destinations” mechanism.

Alternatively, the availability of the discount offer may not be revealed until the qualification event has completed because the decision to provide the discount offer may be based on characteristics of the completed qualification event. Consequently, the discount offer may not be provided to all users who participate in the qualification event, even if the users complete the qualification event.

In one or more embodiments, discount offers 214 include an upgrade option on a travel product that is revealed to the user after the user has committed to purchase the travel product. For example, the user may be notified of the opportunity to upgrade a hotel room at a three-star hotel to a hotel room at an unidentified four-star hotel after the user makes a non-refundable booking of the three-star hotel room. After the user provides payment information and agrees to be charged for the three-star hotel booking, the user may be presented with details of the four-star hotel and the option to upgrade to the four-star hotel. Upgrade options for travel products are described in a co-pending non-provisional application by inventors Alek Strygin, Alek Vernitsky and Ilya Gluhovsky, entitled “Using Upgrade Options to Provide Price Differentiation for Travel Products,” having Ser. No. 14/021,598 and filing date 10 Sep. 2013 (Attorney Docket No. GG12-1003), which is incorporated herein by reference.

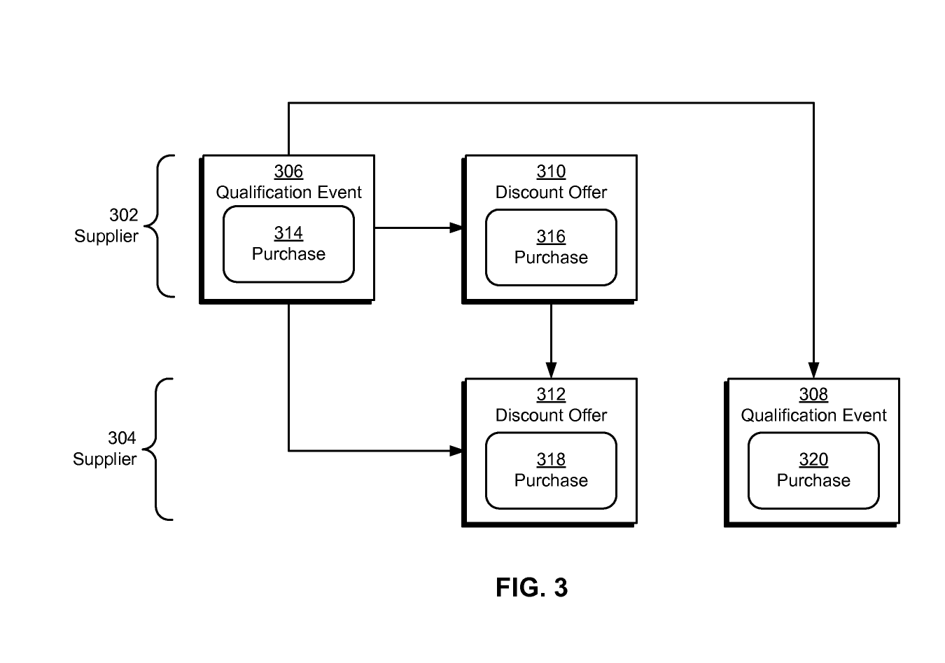

Price-differentiation framework 202 may additionally include functionality to combine multiple qualification events 212 and/or discount offers 214 for the user. For example, analysis apparatus 210 and presentation apparatus 208 may use rules from rules repository 240 to provide a second discount offer to the user after the user accepts the first discount offer provided after the qualification event, which may also include a discount offer. The second discount offer may use information from the first discount offer and/or qualification event to further target the user. Analysis apparatus 210 may also associate the user with another market segment after detecting the user's participation 222 in a second qualification event associated with the other market segment. Analysis apparatus 210 and presentation apparatus 208 may then use rules from rules repository 240 to provide an additional discount offer to the user based on the other market segment, in lieu of or in addition to the second discount offer. In other words, price-differentiation framework 202 may use qualification events 212 and previously accepted discount offers to target the user with additional discount offers on travel products, which may also be qualification events. Targeting users using sequences of qualification events and discount offers is discussed in further detail below with respect to FIG. 3.

Consequently, price-differentiation framework 202 may provide a more robust market-segmentation mechanism than a market-segmentation mechanism that relies on a single qualification event and/or isolated hurdles such as opaque purchases. The use of restrictions and/or rules to provide chained qualification events and/or discount offers may further facilitate effective segmentation of users 204-206. Moreover, such chaining of qualification events 212 and/or discount offers 214 may produce a purchase flow of travel products, such as air travel followed by a hotel room and/or a rental car. Offering value-added transactions (e.g., discount offers 214) at various steps of the flow may allow suppliers to increase user participation and satisfaction, which in turn may increase the user's likelihood of staying with the flow. Finally, market segments 218 and/or other data associated with participation 222 in qualification events 212 and/or acceptance of discount offers 214 may be used by independent suppliers to further characterize and/or target the user.

Moreover, qualification events 212 and discount offers 214 may allow price-differentiation framework 202 to apply market segmentation to tiered transactions that involve more than a single transaction. Examples of conventional tiered transactions may include “Buy 7 Get 1 Free” offers, group discounts at fitness clubs, discounted car washes after gas fills at gas stations, and/or offering a gift after completing a sale (e.g., at a department store). The conventional tiered transactions may be designed to increase the value of the original purchase to consumers, and may be advertised up front to increase consumer participation. On the other hand, tiered transactions may be performed by price-differentiation framework 202 for the purpose of market segmentation, where special pricing is made to select users on a personalized basis. Price-differentiation framework 202 may thus treat user touch points as qualifying events and, optionally, as behavioral data generators, while allowing multiple independent (e.g., non-colluding) suppliers to administer these touch points. User- or time-based restrictions may additionally play an important part in ensuring effective segmentation. In other words, discount offers 214 may be viewed as up-selling opportunities targeted at the right market segments.

Those skilled in the art will appreciate that the system of FIG. 2 may be implemented in a variety of ways. First, presentation apparatus 208, analysis apparatus 210, processing apparatus 216, rules repository 240, and inventory repository 220 may be provided by a single physical machine, multiple computer systems, one or more virtual machines, a grid, one or more databases, one or more filesystems, and/or a cloud computing system. In addition, presentation apparatus 208, analysis apparatus 210, and/or processing apparatus 216 may be implemented together or separately by one or more hardware and/or software components and/or layers.

Second, qualification events 212, market segments 218, and discount offers 214 may be used to provide segmentation of users 204-206 in a number of ways. As mentioned above, chaining of qualification events 212 and discount offers 214 may facilitate increased segmentation, price differentiation, and/or targeting of users 204-206. Similarly, market segments 218 may be redefined as information about users 204-206 is collected through participation 222 in qualification events 212 and/or purchases 230 of discount offers 214. Finally, qualification events 212 may not require the use of hurdles and/or purchases associated with the hurdles. For example, a user's market segment may be established based on the user's filters, settings, and/or purchases associated with travel products that are not subject to opacity and/or uncertainty.

FIG. 3 shows an exemplary use of qualification events 306-308 with a set of discount offers 310-312 in accordance with the disclosed embodiments. First, a user may participate in qualification event 306 associated with a first supplier 302 by making a purchase 314 associated with qualification event 306. For example, the user may make purchase 314 after accepting and/or overcoming a hurdle, such as an opaque purchase with or without purchase options, a destination uncertainty, a time uncertainty, and/or a purchase commitment with an upgrade option.

In turn, the user may be associated with a market segment, which may qualify the user for discount offer 310. For example, the user's participation in the hurdle from qualification event 306 may place the user in a price-sensitive “leisure” market segment and allow the user to receive discount offer 310 from the same supplier 302 on a travel product that is normally priced for inflexible and/or less price-sensitive business travelers. The user may then make a purchase 316 using discount offer 310.

Qualification event 306 and discount offer 310 may also be used by a second supplier 304 to qualify the user for additional discount offers and/or target the user based on the user's market segment. As shown in FIG. 3, supplier 304 may use information from previous purchases 314-316 for both qualification event 306 and discount offer 310 to generate discount offer 312 for purchase 318 by the user. In particular, supplier 304 may use qualification event 306 to identify the user's market segment and determine that the user is eligible for discount offer 312. Supplier 304 may then use discount offer 310 to generate a related and/or complementary discount offer 312 with which to target the user. For example, supplier 304 may use an opaque purchase 314 of a hotel room as qualification event 306, which associates the user with a price-conscious, flexible market segment. Next, supplier 304 may use a discounted purchase 316 of a whale-watching tour following the opaque purchase 314 to infer the user's interest in outdoor activities and target the user with discount offer 312 for a different outdoor activity (e.g., bicycle tour, snorkeling tour, parasailing, etc.). Because discount offer 312 is personalized to the user based on purchases 314-316, supplier 304 may stand a greater chance of the user making purchase 318 than if supplier 304 provided a generic or untargeted discount offer to the user.

Similarly, supplier 304 may require the user to participate in an additional qualification event 308 after participating in qualification event 306 to make a purchase 320 associated with qualification event 308. Qualification event 308 may be used to further assess the user's market segment and determine the user's eligibility for purchase 320. Such chaining of qualification events 306-308 may be used to offer deep discounts and/or prevent cannibalization of other market segments by purchase 320.

For example, qualification event 306 may be an “alternative destinations” mechanism that results in purchase 314 of a travel itinerary to a destination selected by the “alternative destinations” mechanism. In turn, qualification event 308 may include an upgrade option on a non-refundable hotel booking, which is completed with the non-refundable booking and exercise of the upgrade option. Qualification event 308 alone may cannibalize a full-price booking of the hotel associated with the upgrade option from a business traveler if the business traveler's organization is willing to exercise the upgrade option in lieu of booking a premium hotel with a known identity. However, such cannibalization may not occur if qualification event 308 is coupled with qualification event 306 because the business traveler would not have the flexibility to purchase the travel itinerary using the “alternative destinations” mechanism. Conversely, qualification event 308 may deter a leisure traveler who attempts to use the “alternative destinations” mechanism to purchase a flight to a cheap destination with expensive hotels and receive a subsequent, guaranteed discount offer (e.g., discount offers 310-312) on a hotel at the destination. In other words, the combination of qualification events 306-308 may reduce the likelihood of a user in the wrong market segment circumventing both qualification events 306-308.

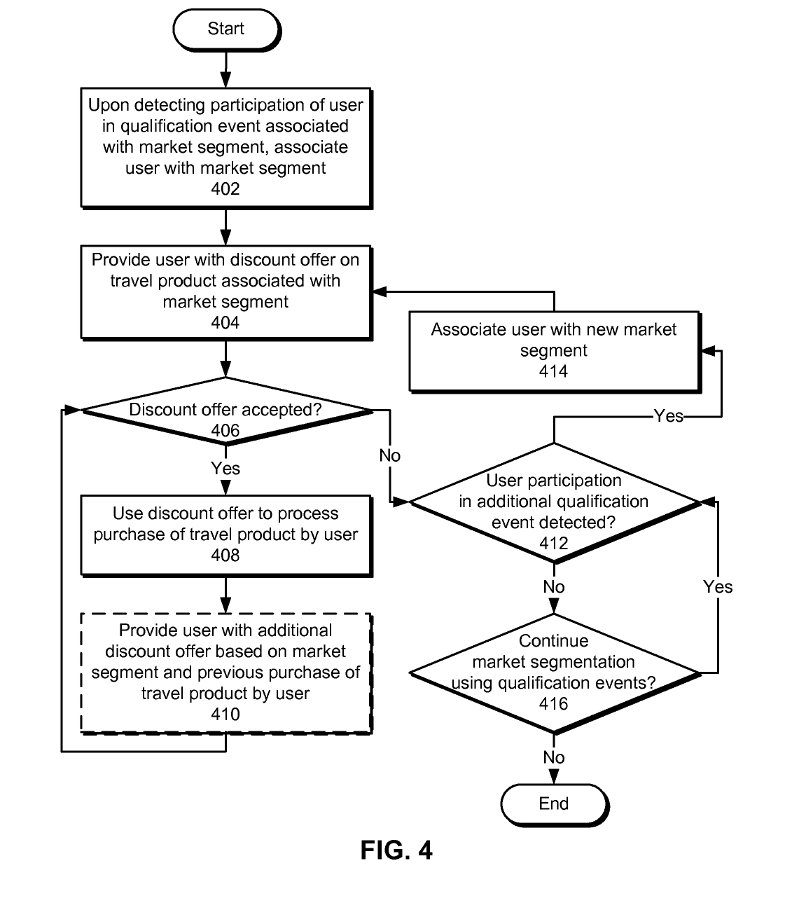

FIG. 4 shows a flowchart illustrating the process of facilitating a purchase of a travel product in accordance with the disclosed embodiments. In one or more embodiments, one or more of the steps may be omitted, repeated, and/or performed in a different order. Accordingly, the specific arrangement of steps shown in FIG. 4 should not be construed as limiting the scope of the embodiments.

Initially, a user is associated with a market segment upon detecting the user's participation in a qualification event associated with the market segment (operation 402). The qualification event may include a hurdle, an opaque purchase, a set of purchase options for the opaque purchase, an upgrade option, destination uncertainty, and/or time uncertainty. As a result, the qualification event may segment the user from users who are not willing to jump the hurdle and/or have a lower tolerance for opacity or uncertainty. In addition, the user's participation in the qualification event may include accessing (e.g., browsing, searching, etc.) one or more travel products associated with the qualification event and/or the user's completion of the qualification event. Similarly, the user's participation may be detected by enabling the user's participation (e.g., browsing, searching, purchasing, etc.) in the qualification event or verifying the user's participation in the qualification event (e.g., by obtaining evidence of the user's participation from the user).

Next, the user is provided with a discount offer on a travel product associated with the market segment (operation 404). For example, the user may be offered a discount and/or an upgrade option on a hotel room at a destination after booking a flight to the destination using an “alternative destinations” mechanism. To mitigate “gaming” of the qualification event and/or discount offer by the user and/or other users, the discount offer may be associated with a period of validity, a value associated with the first qualification event, a personalized discount, and/or use of the travel product by the user or another user associated with the first qualification event. The discount offer may then be accepted by the user (operation 406). If the discount offer is accepted, the discount offer is used to process the user's purchase of the travel product (operation 408).

In addition, the user may optionally be provided with an additional discount offer based on the market segment and the previous purchase of the travel product by the user (operation 410). For example, the qualification event may qualify the user for the additional discount offer, while the user's previous purchase of the travel product may be used to tailor the additional discount offer to the user's needs, desires, and/or preferences. The additional discount offer may be associated with the same supplier as the initial discount offer, or the additional discount offer may be associated with a different supplier.

If the additional discount offer is provided to the user, a purchase using the additional discount offer may be processed based on the user's acceptance of the additional discount offer (operation 406-408). Alternatively, no purchase may be made with the additional discount offer if the user does not accept the additional discount offer. Other discount offers may also be provided (operation 410) and processed (operations 406-408) based on the user's market segment and/or purchase of other discount offers.

The user's participation in an additional qualification event may also be detected (operation 412). For example, the user may participate in an opaque purchase of a hotel room with purchase options after purchasing a flight using an “alternative destinations” mechanism. Because both purchases are associated with hurdles, the purchases may enable greater segmentation of the user than if each hurdle were used alone. Each qualification event may also include a discount offer and/or be associated with the same or different suppliers. If the user's participation in the additional qualification event is detected, the user is associated with a new market segment (operation 414). The user may then be provided with one or more discount offers associated with the new market segment (operations 404-410).

Market segmentation using qualification events may continue (operation 416) during the user's access to and/or purchase of travel products. If market segmentation is to continue, the user's participation in qualification events (operation 412) is used to associate the user with different market segments (operation 414), and the user is provided with discount offers based on the market segments and/or the user's purchases using other discount offers (operations 404-410). Market segmentation of the user may continue until the user has completed searching, browsing, and/or purchasing travel products (e.g., during a purchase flow of travel products for upcoming travel).

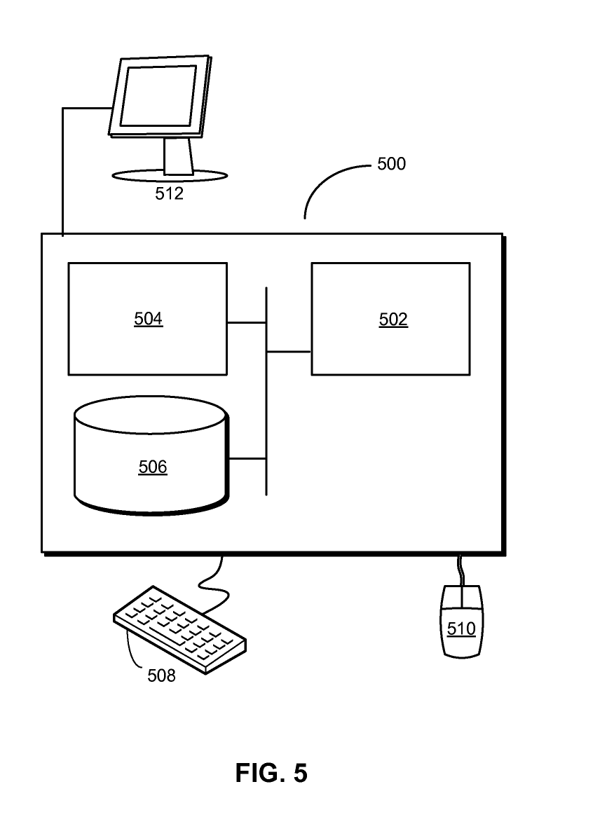

FIG. 5 shows a computer system 500 in accordance with an embodiment. Computer system 500 may correspond to an apparatus that includes a processor 502, memory 504, storage 506, and/or other components found in electronic computing devices such as personal computers, laptop computers, workstations, servers, mobile phones, tablet computers, and/or portable media players. Processor 502 may support parallel processing and/or multi-threaded operation with other processors in computer system 500. Computer system 500 may also include input/output (I/O) devices such as a keyboard 508, a mouse 510, and a display 512.

Computer system 500 may include functionality to execute various components of the present embodiments. In particular, computer system 500 may include an operating system (not shown) that coordinates the use of hardware and software resources on computer system 500, as well as one or more applications that perform specialized tasks for the user. To perform tasks for the user, applications may obtain the use of hardware resources on computer system 500 from the operating system, as well as interact with the user through a hardware and/or software framework provided by the operating system.

In one or more embodiments, computer system 500 provides a system for facilitating a purchase of a travel product. The system may include an analysis apparatus that associates a user with a first market segment upon detecting a participation of the user in a first qualification event associated with the first market segment. The system may also include a presentation apparatus that provides the user with a first discount offer on a first travel product associated with the first market segment. Finally, the system may include a processing apparatus that uses the discount offer to process a purchase of the first travel product by the user upon obtaining an acceptance of the first discount offer from the user.

In addition, one or more components of computer system 500 may be remotely located and connected to the other components over a network. Portions of the present embodiments (e.g., presentation apparatus, analysis apparatus, processing apparatus, etc.) may also be located on different nodes of a distributed system that implements the embodiments. For example, the present embodiments may be implemented using a cloud computing system that uses qualification events and discount offers to provide price differentiation of travel products to a set of remote users.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A computer-implemented method for facilitating a purchase of a travel product, comprising:
upon detecting a participation of a user in a first qualification event associated with a first market segment, associating the user with the first market segment;
providing the user with a first discount offer on a first travel product associated with the first market segment; and
upon obtaining an acceptance of the first discount offer from the user, using the first discount offer to process a purchase of the first travel product by the user.

2. The computer-implemented method of claim 1, further comprising:
upon detecting a participation of the user in a second qualification event associated with a second market segment, associating the user with the second market segment; and
providing the user with a second discount offer on a second travel product associated with the second market segment.

3. The computer-implemented method of claim 2,
wherein the first travel product is associated with a first supplier, and
wherein the second travel product is associated with a second supplier.

4. The computer-implemented method of claim 1, further comprising:
providing the user with a second discount offer on a second travel product based on the first market segment and the purchase of the first travel product by the user.

5. The computer-implemented method of claim 1, wherein detecting the participation of the user in the first qualification event involves at least one of:
enabling participation of the user in the first qualification event; and
verifying participation of the user in the first qualification event.

6. The computer-implemented method of claim 1, wherein the participation of the user in the first qualification event comprises at least one of:
accessing one or more travel products associated with the first qualification event; and
completing the first qualification event.

7. The computer-implemented method of claim 1, wherein the first discount offer is associated with at least one of:
a period of validity;
a value associated with the first qualification event;
a personalized discount;
an upgrade option; and
use of the first travel product by the user or another user associated with the first qualification event.

8. The computer-implemented method of claim 1, wherein the first qualification event is associated with at least one of:
a hurdle;
an opaque purchase;
a set of purchase options associated with the opaque purchase;
an upgrade option;
a destination uncertainty; and
a schedule uncertainty.

9. The computer-implemented method of claim 1, wherein the first travel product is at least one of:
a flight;
a hotel;
a rental car;
a cruise;
a tour; and
a travel package.

10. A system for facilitating a purchase of a travel product, comprising:
an analysis apparatus configured to associate a user with a first market segment associated with the first qualification event upon detecting a participation of the user in a first qualification event associated with the first market segment;
a presentation apparatus configured to provide the user with a first discount offer on a first travel product associated with the first market segment; and
a processing apparatus configured to use the first discount offer to process a purchase of the first travel product by the user upon obtaining an acceptance of the first discount offer from the user.

11. The system of claim 10,
wherein the analysis apparatus is further configured to associate the user with a second market segment upon detecting a participation of the user in a second qualification event associated with the second market segment, and
wherein the presentation apparatus is further configured to provide the user with a second discount offer on a second travel product associated with the second market segment.

12. The system of claim 10, wherein detecting the participation of the user in the first qualification event involves at least one of:
enabling participation of the user in the first qualification event; and
verifying participation of the user in the first qualification event.

13. The system of claim 10, wherein the participation of the user in the first qualification event comprises at least one of:
accessing one or more travel products associated with the first qualification event; and
completing the first qualification event.

14. The system of claim 10, wherein the first discount offer is associated with at least one of:
a period of validity;
a value associated with the first qualification event;
a personalized discount;
an upgrade option; and
use of the first travel product by the user or another user associated with the first qualification event.

15. The system of claim 10, wherein the first qualification event is associated with at least one of:
a hurdle;
an opaque purchase;
a set of purchase options associated with the opaque purchase;
an upgrade option;
a destination uncertainty; and
a schedule uncertainty.

16. A non-transitory computer-readable storage medium storing instructions that when executed by a computer cause the computer to perform a method for facilitating a purchase of a travel product, the method comprising:
upon detecting a participation of a user in a first qualification event associated with a first market segment, associating the user with the first market segment;
providing the user with a first discount offer on a first travel product associated with the first market segment; and
upon obtaining an acceptance of the first discount offer from the user, using the first discount offer to process a purchase of the first travel product by the user.

17. The non-transitory computer-readable storage medium of claim 16, the method further comprising:
upon detecting a participation of the user in a second qualification event associated with a second market segment, associating the user with the second market segment; and
providing the user with a second discount offer on a second travel product associated with the second market segment.

18. The non-transitory computer-readable storage medium of claim 16, wherein detecting the participation of the user in the first qualification event involves at least one of:
enabling participation of the user in the first qualification event; and
verifying participation of the user in the first qualification event.

19. The non-transitory computer-readable storage medium of claim 16, wherein the first discount offer is associated with at least one of:
a period of validity;
a value associated with the first qualification event;
a personalized discount;
an upgrade option; and
use of the first travel product by the user or another user associated with the first qualification event.

20. The non-transitory computer-readable storage medium of claim 16, wherein the first qualification event is associated with at least one of:
a hurdle;
an opaque purchase;
a set of purchase options associated with the opaque purchase;
an upgrade option;
a destination uncertainty; and
a schedule uncertainty.
